(19) United States
(12) Patent Application Publication
(10) Pub. No.: US 2020/0045026 A1
(43) Pub. Date: Feb. 6, 2020

(54) Centralized Data Management and SaaS with End-to-End Encryption

(71) Applicants: Dmitry Sagalovskiy, New York, NY (US); Yaroslav Sagalovskiy, Washington, DC (US)

(72) Inventors: Dmitry Sagalovskiy, New York, NY (US); Yaroslav Sagalovskiy, Washington, DC (US)

(21) Appl. No.: 16/531,012

(22) Filed: Aug. 2, 2019

Related U.S. Application Data
(60) Provisional application No. 62/714,632, filed on Aug. 3, 2018.

(51) Int. Cl. H04L 29/06; H04L 9/08; H04L 9/32; H04L 9/14

(52) U.S. Cl. CPC H04L 63/0435; H04L 9/0825; H04L 63/102; H04L 9/3271; H04L 9/14; H04L 9/0822

(57) ABSTRACT

New techniques for securely managing cloud-based data, documents and software-as-a-service (“SaaS”) are provided. In some embodiments, End-to-End encryption is carried out for aspects of a group project managed via a system including a remote server hub delivering SaaS. Structured data and project content are all managed securely by the server hub and end users. In some embodiments, the end users share new types of encryption keys (and bundles thereof) to securely decrypt data, while the server manages the data, yet remains blind to data contents due to encryption. In some embodiments, the server hub, even though blind to data contents due to encryption, is still able to manage data differently based on its content, via unique new encrypted data management tools. For example, in some aspects of the invention, new data, and alterations to the structured data and project content, are managed by tools referred to as “change objects.”

### CROSS-REFERENCE TO RELATED APPLICATION

This application claims priority to U.S. Provisional Application No. 62/714,632, filed Aug. 3, 2018, titled “End-to-End Encryption for Software-as-a-Service Systems,” the contents of which are hereby incorporated by reference into the present application in their entirety, as if fully set forth herein.

### FIELD OF THE INVENTION

The present invention relates to the field of cryptography. The present invention also relates to the field of cloud-based software and data management and software-as-a-service (“SaaS”) systems. In particular, the present invention relates to cloud-based management of multi-user, collaborative software.

### BACKGROUND

Since the dawn of civilization, teams of people have sought to collaborate in work environments to increase their productivity. Indeed, the concept of civilization itself is closely tied to organized human collaboration, and its effects have been quite striking throughout history.

Beginning at least with ancient Sumer, systems of written collaboration developed, in the context of agricultural trade. Sumerians would drop symbolic tokens into clay envelopes, and then press the clay against them, creating a visible impression of the symbols on the outside. Holders of the envelopes could then prove their entitlement to corresponding livestock and produce, aiding in agricultural planning and management. Over time, the Sumerians abandoned the tokens, realizing that the impressions created by them on a clay substrate were sufficient. The earliest form of writing then developed—cuneiform—in which a reed stylus was pressed into the clay to create written symbols, signifying language.

In modern times, extremely sophisticated computer systems have been integrated into the fabric of society. Software has been developed, at least in part, to aid in collaborative writing and recordkeeping, including, perhaps most prevalently, MICROSOFT's OFFICE suite of software products, such as the EXCEL program, for creating, editing and managing spreadsheet documents, such as financial statements, and the WORD program, for word processing. Several of such software products have been offered for download or use on remote servers via the Internet, by companies like MICROSOFT. Typically, a user may pay a monthly subscription fee to access the software over the Internet (perhaps after a free trial period). If the user terminates his or her account with the company, or if the terms for access are violated (e.g., failing to pay for access after a given time), use of the software may be easily, remotely terminated by a system administrator managing the servers. In some systems (e.g., GOOGLE's suite of cloud-based software products, such as GOOGLE DOCS) a password-protected, encrypted user account, along with data necessary for execution of the software, may be held remotely on the servers, rather than on local, client computer hardware. Such systems and software may be referred to as “cloud-based” or “in the cloud,” meaning that a user need not rely on any particular local, client device to access the software, and can instead access his or her account virtually anywhere, over the Internet (a widespread resource in most countries and regions today). Among other advantages to a cloud-based approach, updates to the software and other facilities can be administered more easily, at a remote, central location, with the latest versions, patches and other updates immediately provided to all client devices, as an ongoing service. Thus, such cloud-based systems of this nature may be referred to as “Software-as-a-Service” (hereinafter, “SaaS”).

The field of cryptography, involving the encoding and decoding of secure messages, has also existed for thousands of years. Early forms of cryptography included the transposition and substitution of language characters in accordance with a cipher—a privately held “key” prescribing rules for encoding messages and making them illegible to unauthorized, intercepting third parties (a.k.a. “adversaries”). By sharing that key between the sender and a recipient, and keeping it secret from third parties, encoded messages could be sent in secrecy, despite interception or eavesdropping. The earliest forms of cryptography employed simple rules for character transposition and/or substitution—e.g., by rearranging character positions, by replacing consonants with vowels, by replacing one particular character with another particular character (as in Julius Caesar's Cipher), or by some combination of such rules. By today's standards, such rules are considered weak forms of cryptography, extremely vulnerable to decoding by known cryptanalysis techniques. For example, the incidence of characters and words within the English language are well understood, and can be simply applied to determine which transposed or substituted characters likely stand for the corresponding original plaintext character in a given message. Harder forms of cryptography, involving polyalphabetic, rolling ciphers, where the substitution key is more complex and dynamic than a one-to-one character or position substitution, made such language frequency cryptanalysis much more difficult. One such famous example is the ENIGMA machine, used by the German military to encode messages in World War II. As shown by that example, in which the ENIGMA machine was ultimately cracked by the Allied Forces, even such sophisticated systems are still vulnerable to the realities of adversary discovery, partial discovery and cryptanalysis. For most cases, however, rolling, complex ciphers can provide very strong encryption to this day, because the resources required to decode them can easily far outweigh the corresponding benefit to adversaries.

Complex, rolling, one-time ciphers, shared only by a sender and a recipient (as in “End-to-End” encryption) can be made particularly secure. In End-to-End encryption, two communicators share a privately held, pre-shared key, known only to them, for encrypting messages before sending them to the other over a network, and decrypting the messages when received. The data may be managed, stored and resent by dozens of web servers or other network intermediaries, but it remains secure the entire time in transit, because those third parties do not have the key for decoding it. In theory, if implemented correctly (i.e., with a rolling, sufficiently long and random character or other data substitution scheme, and adequate secrecy in pre-sharing the key, or other very strong forms of encryption keys) End-to-End encryption is thought to be impossible to crack by third parties, even in relatively simple forms (e.g., a “one-time pad” of random, non-repeating, serial substitution characters). However, in practice, some attacks may still be effective even against strong forms of End-to-End encryption under some circumstances (e.g., “man-in-the-middle” attacks and “back door” attacks.) Among other weaknesses in character substitution schemes, ciphers cannot always be made long and random enough in practice, especially in light of escalating brute force attacks from powerful computer systems used by adversaries. A cipher typically employs a substitution library, of a particular (albeit large) key length. For example, the Data Encryption Standard (“DES”) developed in the 1970's for government documents employs a 56-bit key, corresponding with 2⁵⁶ (or approximately 72 quadrillion) possible permutations. Yet, DES was cracked by brute force attacks within 3 days as early as 1998. Similarly, as a practical matter, and particularly when initiating secure communication over the Internet, the private key must be shared at some point between the communicators (e.g., through an initial security “handshake”) at which point the cipher or other security algorithm is vulnerable to discovery by adversaries (as in the man-in-the-middle attack).

To reduce man-in-the-middle attacks and other initial security key sharing vulnerabilities, “asymmetric key” or “public key” cryptography was developed in the mid-1970's. In asymmetric key cryptography, the communicators need not pre-share the exact same, private key. Rather, one key (the “public key”) may be distributed widely, and used by anyone to encrypt data, while only a second, mathematically-related key is held privately (the “private key”), and can be used to decrypt the encrypted messages. While, in theory, any mathematical relationship can be discovered through sufficient analysis, asymmetric key cryptography employs mathematical relationships that are extremely difficult to discover, yielding very strong private keys despite the publication of the corresponding public key. Typically, those relationships are born from number theory, such as the Discrete Logarithm Problem or factorization. There is no known efficient, non-brute force solution for discovering such relationships, but they may be generated with relative ease (e.g., multiplication of two numbers is far easier than discovering them from their multiplication product through factorization, particularly with a set of large numbers.)

Because asymmetric key cryptography is more resource-intensive than conventional, “symmetric key” cryptography (using two copies of the same key for both encryption and decryption), hybrid approaches have been developed to exploit the strength of the former and the efficiency of the latter. For example, in some encryption schemes, such as Pretty Good Privacy (“PGP”), a message may be encoded and bundled with a symmetric key in a package sent to a recipient, with the symmetric key itself encrypted with an asymmetric public key. Using the corresponding private key, the recipient can then decode the new symmetric key and the message, and the communicators may re-use the symmetric key in the future, with or without further asymmetric encryption.

It should be noted that some of the disclosures set forth as background, such as, but not limited to, the above language under the heading “Background,” do not relate exclusively to prior art and the state of the art in the field(s) of the invention, and should not be construed as an admission with respect thereto.

### SUMMARY OF THE INVENTION

New techniques for securely managing cloud-based data, documents and software-as-a-service (“SaaS”) are provided. In some embodiments of the invention, End-to-End encryption is carried out for aspects of a group project managed via a system including a remote server hub delivering SaaS. Structured data and project content are all managed securely by the server hub and end users. In some embodiments, the end users share new types of encryption keys (and bundles of keys) to securely decrypt data, while the server manages the data, yet remains blind to data contents due to encryption. In some embodiments, the server hub, even though blind to data contents due to encryption, is still able to manage the structured data and project content differently based on its content, via unique new encrypted data management tools. For example, in some aspects of the invention, new data, and alterations to the structured data and project content, are managed by tools referred to in this application as “change objects.”

The techniques may include methods and systems, which systems may comprise computer hardware and software, including non-transitory machine-readable media with executable instructions. When executed by a computer system, the instructions may cause the systems to carry out any or all of the methods set forth herein.

These and other aspects of the invention will be made clearer below, in other parts of this application. This Summary, the Abstract, and other parts of the application, are for ease of understanding only, and no part of this application should be read to limit the scope of the invention, whether or not it references matter in any other part.

### BRIEF DESCRIPTION OF THE DRAWINGS

FIG. 1 depicts an example implementation environment, including, but not limited to, an example computer hardware system carrying out example End-to-End encryption techniques in accordance with some embodiments of the present invention.

FIG. 2 depicts some examples of secure data encryption techniques, including the communication of an example change object from a user device to a cloud-based hub, in accordance with some embodiments of the present invention.

FIG. 3 depicts some additional examples of secure data encryption techniques, including the communication of another type of change object, in accordance with some embodiments of the present invention.

FIG. 4 is a schematic block diagram of some elements of an example control system that may be used to implement various embodiments of the present invention, some of which embodiments are described in reference to FIGS. 1, 2, 3 and 5 of this application.

FIG. 5 is a process flow diagram, setting forth several example steps that may be undertaken by a control system (such as the example control system set forth above, in reference to FIG. 4) implementing embodiments of the present invention.

### DETAILED DESCRIPTION OF THE INVENTION

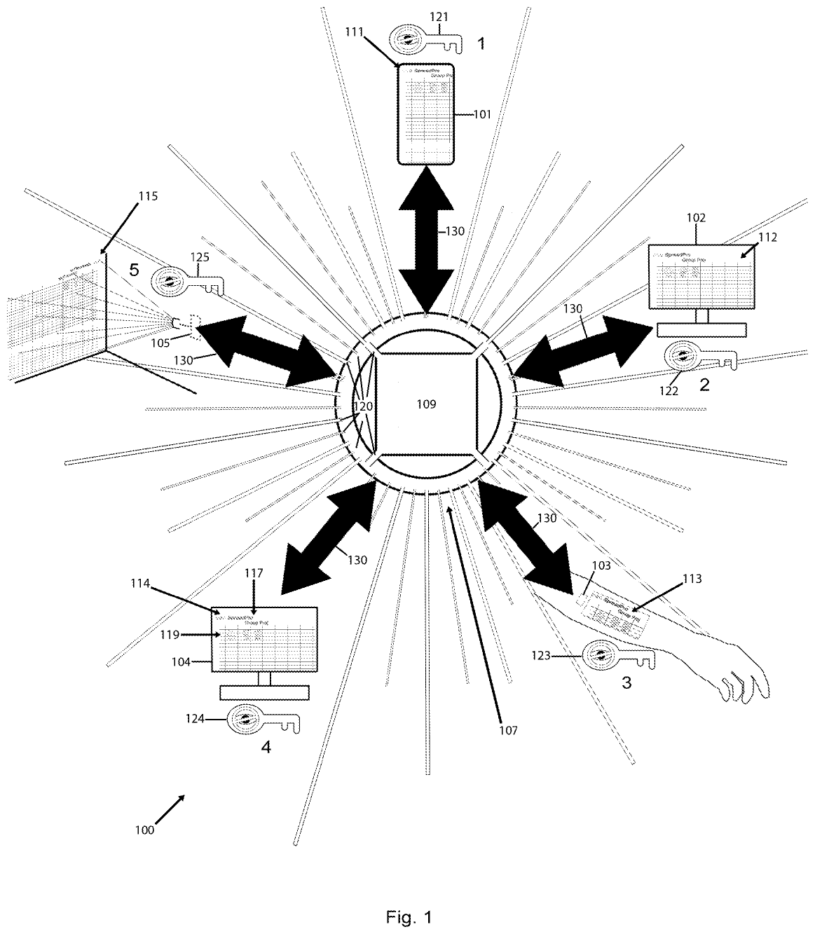

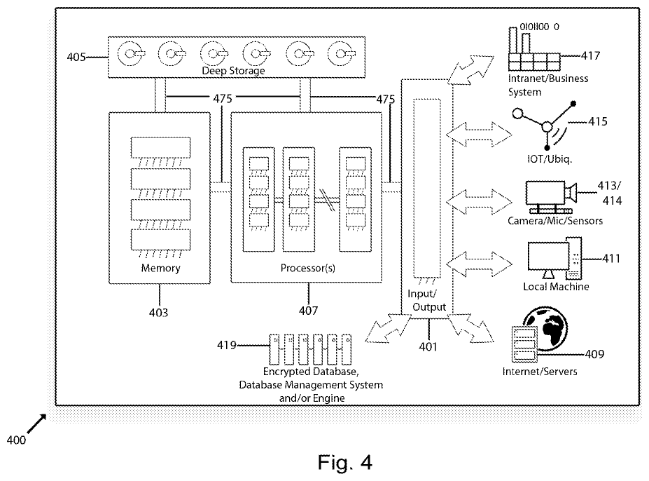

FIG. 1 depicts an example implementation environment 100, including, but not limited to, an example cloud-based hub 107 comprising at least one computer hardware system 109, delivering structured data to several client devices, namely, client device 101, client device 102, client device 103, client device 104 and client device 105, and carrying out exemplary End-to-End encryption techniques in accordance with some embodiments of the present invention. As with other example environments, the hardware and other aspects set forth with respect to this figure are only examples, not exhaustive, of the many possible alternative use environments that fall within the scope of the invention, as will be readily apparent to those of ordinary skill in the art. For instance, instead, several more, or fewer, client devices, or a different order thereof, than pictured in the figure, in some other embodiments. In some embodiments, several more such hubs may be used that pictured in the figure. Several more computer hardware systems may be used instead of the computer hardware system 109 shown, in some embodiments of the present invention. In some embodiments, computer hardware system 109 may be the example system set forth below, in reference to FIG. 4, below. In some embodiments, computer hardware system 109 may be any system implementing non-transitory computer hardware known in the art, specialized to carry out any embodiments of the present invention set forth in this application. In some embodiments, a virtual server may be used, instead of the computer hardware system shown. Similarly, and also by no means exhaustive, a different organization or order of any embodiment of the example environment may be used to implement aspects of the present invention, alternatively or in addition to the arrangement pictured.

The exact detailed embodiments provided, including the devices, hardware, software, and GUI elements set forth in the figures and discussed in detail in this application are, of course, exemplary, and not limiting. Rather, these embodiments are intended only as a reasonable set of possible example structures, substructures, materials, methods, steps and other aspects of the present invention, among virtually infinite and innumerable possibilities for carrying out the present invention, to ease comprehension of the disclosure, as will be readily apparent to those of ordinary skill in the art. For instance, as mentioned above, the description of one particular order, number or other arrangement of any aspects of the present invention set forth herein is illustrative, not limiting, and all other possible orders, numbers, etc., are also within the scope of the invention, as will be so readily apparent. Any aspect of the invention set forth herein may be included with any other aspect in a particular embodiment, as well as any aspects known in the art, in any number, order, arrangement, or alternative configuration while still carrying out, and falling within, the scope of the invention.

As will be discussed in greater detail below, computer hardware system 109, and any of the client devices 101 through 105, may comprise, or may be comprised within, a control system, such as, but not limited to, the example control system set forth in reference to FIG. 4, below. In any event, in some embodiments, such control system(s) may be configured (e.g., by such computer software, computer hardware and methods discussed further below, in this application) to carry out any and/or all of the example steps for encrypting, sharing and managing data and providing collaborative software to an end user, and any other steps and embodiments set forth in the present application.

For example, as shown in environment 100, hub 107 manages the delivery of encrypted, structured data in the furtherance of providing software as a service (“SaaS”) to a number of users, in instances, depicted as example instance 111, example instance 112, example instance 113, example instance 114 and example instance 115, of that software on example client device 101, example client device 102, example client device 103, example client device 104, and example client device 105, respectively. For example, in each instance (instance 111, instance 112, instance 113, instance 114 and instance 115) of the software program, presented on each client device (in this example, client device 101, client device 102, client device 103, client device 104 and client device 105) each user may be viewing a graphical user interface (“GUI”) generated by the software, such as example GUI 117, which GUI allows the user to view, edit and otherwise manage a document, such as example spreadsheet 119, using the software.

To provide instance 111, instance 112, instance 113, instance 114 and instance 115 of the SaaS, on client device 101, client device 102, client device 103, client device 104 and client device 105, cloud-based hub 107 may have a number of communications connections, such as the examples pictured as communications connections 120. Communications connections 120 may be hard-wired in some embodiments. For example, in some such embodiments, communications connections 120 may include any number of electrically conductive communications cables of any known, suitable material known in the art. In some embodiments, communications connections 120 include wireless communications connections. For example, in some embodiments, communications connections 120 include one or more WiFi connection(s). As another example, in some embodiments, communications connections 120 include one or more Bluetooth connections. As yet another example, in some embodiments, communications connections 120 include one or more Cellular connections. In some embodiments, at least some of communications connections 120 include computer network communications connections. For example, in some such embodiments, communications connections 120 are provided over the Internet. In any event, cloud-based hub 107 communicates with any number of client devices, from one or two client devices, to many thousands or millions of client devices, in various embodiments of the invention. Similarly, in various embodiments, cloud-based hub 107 creates any number of instances of software being provided, from one or two instances, to many thousands or millions of instances of the software being provided. The example environment explicitly shown, with five such client devices—namely, client device 101, client device 102, client device 103, client device 104 and client device 105=13 and five instances of the software—namely instance 111, instance 112, instance 113, instance 114 and instance 115, and its specific example GUI 117, are each and all depicted for the sake of simplicity and comprehensibility of the illustration only, and do not limit the scope of the present invention, as will be readily understood by those of ordinary skill in the art.

In any event, employing at least some of communications connections 120, computer hardware system 109 establishes two-way communications with each active client device for which it is to deliver the SaaS, as shown by two-way communications arrows 130, which depict a line of communications between the hub 107 and each active client device—in this example, each of client device 101, client device 102, client device 103, client device 104 and client device 105. In some embodiments, an active client device is a device with permission to access the SaaS or other data from cloud-based hub 107. For example, in some embodiments, clients must maintain an account administered by cloud-based hub 107 to access SaaS or other data from cloud-based hub 107. In some such embodiments, a registration protocol may be required prior to granting such an account. In some such embodiments authentication of such accounts and client devices may be required as a prerequisite to providing access to SaaS or other data from cloud-based hub 107. In some embodiments, payment of a subscription fee by a client must be confirmed prior to providing access to SaaS or other data from cloud-based hub 107. In some embodiments, initially, in the first-time provision of the SaaS or data to a particular client (a.k.a., a “user), and as discussed in greater detail elsewhere in this application, the computer hardware system 109 may provide initial communications authenticating and establishing the client's account. In some such embodiments, a client may be tested with an authentication challenge in such initial communications. For example, in some such embodiments, computer hardware system 109 may require the client to provide unique identifying information. In some such embodiments, a unique login, with a password, is required. In some embodiments, a multifactor authentication challenge is presented to the client.

In any event, upon such authentication, the hardware system may then provide data necessary for delivering and presenting an instance of the SaaS to the user, along with a GUI (such as GUI 117) and other data necessary for viewing, editing and otherwise managing document(s), file(s) and/or other data aspects for which the user has permission or other privileges. In some embodiments of the invention relating to group or team collaborative work on a given set of data (such as a document), multiple users may be provided with at least some of the same data in each of their instances. For example, in some such embodiments, such data and instances may be provided on client device 101, client device 102, client device 103, client device 104 and client device 105. When one user makes changes to that data (e.g., by editing the example spreadsheet 119), updates including that changed data are managed and provided by the computer hardware system 109 to other users, in some embodiments.

As mentioned above, in some embodiments, the data (and changes thereto) may be provided to each user in a secure manner, which may include providing data with End-to-End encryption, using further specialized techniques including “change objects,” as discussed in greater detail below. As also will be discussed in greater detail below, any number of such change objects may be so provided, in some embodiments of the invention. For example, in some embodiments, a user may implement any number of changes to data provided to other clients of the SaaS, and each change to data so provided is implemented with a change object. Thus, an infinite number of such change objects may be provided by and to users at client device 101, client device 102, client device 103, client device 104 and client device 105 over time, in some embodiments. Generally speaking, in some embodiments, the encryption and sharing techniques of the present invention include generating at least one unique private key for each client and instance receiving SaaS and related data via cloud-based hub 107. For example, as pictured, each of private key 121, private key 122, private key 123, private key 124 and private key 125 are generated for client device 101, client device 102, client device 103, client device 104 and client device 105, respectively, through asymmetric cryptography methods (i.e., each such private key is paired with a corresponding public key). Each of the private keys (e.g., private key 121, private key 122, private key 123, private key 124 and private key 125) may be generated by and held exclusively by each respective user, on his, her or its client device, in some embodiments. In the specific example pictured, a different, distinct private key is provided at client device 101, client device 102, client device 103, client device 104 and client device 105. In some embodiments, each such private key is inaccessible to any other user, client or third party having access to the computer hardware system 109. In fact, in some embodiments, no part or copy of any of any of such private keys, is ever present on computer hardware system 109. Instead, in some embodiments, each private key is kept in an encrypted, remote location on the respective user's device. For example, as pictured, private key 122 is kept exclusively within a hard drive of client device 102, namely, a desktop computer system). Each of the corresponding public keys, paired with each of such private keys, by contrast, is widely published through computer hardware system 109, to each and all other users and devices, in some embodiments. For example, as pictured, client device 101, client device 102, client device 103, client device 104 and client device 105 are each provided with a public key corresponding via asymmetric cryptography with a private key held by each other such client device. Also generally speaking, in some embodiments, changes to the SaaS or other data are routed to and from each such client device (from and to each other device) in real time, allowing each user to view and edit any of the SaaS or other data changes. For example, in some such embodiments, edits to a document managed by cloud-based hub 107 are received from one or more of such client devices, and distributed to other client device(s).

Many of these and other aspects of the present invention will be further explained below, with respect to additional figures.

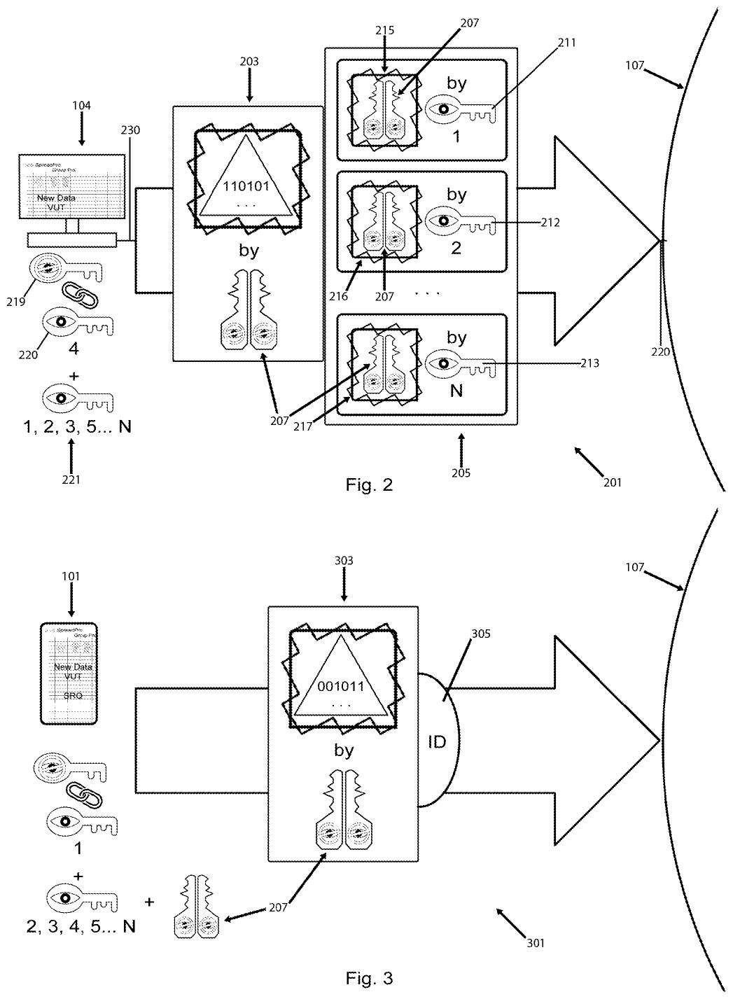

FIG. 2 depicts some examples of secure data encryption techniques, including the communication of an example change object 201 from an example user device (user device 104) to cloud-based hub 107, in accordance with aspects of the present invention. As with other communications to and from cloud-based hub 107, discussed previously, in some embodiments, change object 201 is communicated to hub 107 via any of the communications connections 120 set forth in reference to FIG. 1 (such as example wired connection 230). Regardless which type of communications connection is used, in some embodiments, change object 201 is a set of data including several major components, each of which major components is communicated from client device 104 to cloud-based hub 107. In some embodiments at least some of those major components as so communicated in conjunction with one another. In some embodiments, such major components of change object 201 include: secure, encrypted data 203 and a key bundle 205, necessary for decrypting secure data 203 into plaintext, as will be discussed in greater detail below.

Although, as discussed above in reference to FIG. 1, End-to-End encryption techniques according to some embodiments of the present invention include asymmetric encryption, with one or more matched sets of corresponding public keys and private keys, the present invention also employs symmetric encryption and keys, in some embodiments. In some such embodiments, such symmetric key(s) themselves are encrypted by the public key of particular user(s) and their device(s). For example, in some embodiments supported in FIG. 1, each client device pictured (i.e., client device 101, client device 102, client device 103, client device 104 and client device 105) is used to encrypt such symmetric key(s). However, in some embodiments, such client devices do not encrypt with or send out any of the corresponding private keys, which are each held secret on their respective client device.

By way of example, in some embodiments, and as discussed further below, the encrypted data 203 may be encrypted by generating a new matched symmetric key, such as symmetric key 207, and encoding plaintext data with it. Thus, to extend the example, prior to transmission via wired connection 230, the plaintext data yielding encrypted data 203 is encoded using symmetric key 207. In some embodiments, symmetric key 207 is itself included within change object 201, such that a recipient of change object 201 has the tool, on board change object 201, with which to decrypt encrypted data 203. However, in some such embodiments, in order to prevent eavesdroppers or other unintended third party recipients from decrypting encrypted data 203, symmetric key 207 is itself encrypted within change object 201, by each of the user's public keys (created by asymmetric cryptography techniques, as discussed above, examples of which are shown as public key 211, public key 212 and public key 213), separately, as shown by example asymmetrically encrypted symmetric key 215, asymmetrically encrypted symmetric key 216, and asymmetrically encrypted symmetric key 217. In this way, because only each individual user has access to his, her or its private key corresponding with one of the public keys (public key 211, public key 212, or some public key in the series through public key 213), only the designated, authorized users with such a private key corresponding with one of public key 211 through public key 213, included in key bundle 205, are provided with access to the newly-generated symmetric key 207, and the data 203 encrypted with it. As explained elsewhere in this application, each user of the SaaS authorized to view data shared by collaborating clients through a change object, such as 201, is thus able to view the asymmetrically encrypted symmetric key by using his, her or its private key (which, as explained elsewhere, is exclusively in his, her or its possession in some embodiments, as illustrated in the example shown, by private key 219, paired with corresponding public key 220, and held on exemplary user device 104). More specifically, because each such user can use his, her or its private key, each user may decrypt the version of the symmetric key encrypted with that user's corresponding public key, which version has been sent to him, her or it within key bundle 205 of change object 201. Furthermore, in some embodiments, each user is able to provide symmetric keys asymmetrically encrypted with each, all or any of the other client/users' public keys 221, because each of those public keys 221 have been previously stored on each client's device in some embodiments (e.g., as shown by all of public keys 221 being present on exemplary user's device 104).

However, in some embodiments, once a symmetric key such as symmetric key 207 has been shared by client device 104, through cloud-based hub 107, which then re-sends encrypted data 203 (without decrypting it) to each user designated and authorized to receive it, along with the asymmetrically encrypted symmetric key (encrypted by that user's paired private key), the symmetric key is in each device's memory and, therefore, need not be present in a subsequently-issued key bundle or change object for each user to decrypt data transmissions encrypted with that symmetric key. Thus, in future encrypted data transmissions between collaborative users of the SaaS, such as that illustrated in FIG. 3, using example change object 301, a new, asymmetrically encrypted symmetric key might not be included, as unnecessary. In some embodiments, a change object may include a plurality of such symmetric keys, asymmetrically encrypted with the public key of each user designated to receive it, and any of such symmetric keys may be so used to encode data shared between the users. In some such embodiments, such a plurality of such symmetric keys may be provided within a key bundle. However, if a user or administrator of the SaaS wishes to differently restrict access to any data, or otherwise deliver different data to different users, or, periodically (for example, if a user of the system determines that it may protect against hacking to cycle in new symmetric keys after some time has passed) new symmetric key(s) may again be generated and encrypted with multiple layers, as illustrated in some embodiments shown in FIG. 2 (e.g., as in the asymmetrically encrypted symmetric key pictured) to grant each such authorized user access to the new symmetric key and data. In some embodiments, the control system of hub 107 can manage access to data, documents and other aspects of the SaaS, at any given time, in accordance with the authorizations and designations of users. In some such embodiments, administrative users or other users with superior privileges make such authorizations and designations. As just one example, in some embodiments, the computer hardware system 109 (e.g., a control system) of cloud-based hub 107 may determine (e.g., by metadata) which users' public keys have been used to encrypt symmetric key 207. In some such embodiments, such metadata is unencrypted. In some embodiments, such metadata is differently encrypted than the symmetric key or the data within the change object (that has been symmetrically encrypted.) The control system may then determine that the change object is to be forwarded to each such user's corresponding device, in one such embodiment. In some embodiments, the control system creates a copy of the change object for each user designated and authorized to receive it, along with the symmetric key encrypted by that user's public key only. In some embodiments, if some such users currently are not logged in, or otherwise are not available for communication with hub 107, the hub may maintain a copy of the change object (such as change object 201), to be distributed to such users once they are back online, or otherwise are able to communicate with the hub. Similarly, if new users, altogether, are added to a project or other collaboration using the SaaS managed by hub 107, a group of all previous, relevant change objects may be sent to such new users. In other embodiments, a single, larger change object, with data producing all historical changes to the project data, may be sent at once to the new users. In some embodiments, change objects are distributed to all other users authorized to receive it immediately after they are received.

As mentioned above, FIG. 3 also depicts some examples of secure data encryption techniques, including the communication of another type of change object 301 from a user device (this time, different example device 101, a smartphone using a wireless connection, which connection is not pictured) to the same cloud-based hub 107, in accordance with aspects of the present invention. In some embodiments change object 301 has been generated after device 101 received change object 201, discussed above. As a result, and because each such device previously received symmetric key 207, and was able to decrypt it using its private key, as discussed above, devices such as 101, including all other such devices for currently authorized collaborating users, already each have a copy of symmetric key 207. Thus, as alluded to above, for purposes of the communication of change object 301, a key bundle is not included within change object 301. Instead, the new, encrypted data 303, carried within object 301, is simply encrypted with symmetric key 207.

In some embodiments, to aid in routing change object 301 to particular, designated users, without resorting to generating a new symmetric key encrypted by an asymmetric key, an identifier packet 305 may instead be provided. In some embodiments, identifier packet 305 identifies each and every user authorized and designated to receive the new encrypted data 303. For example, in some such embodiments, identifier packet 305 identifies such users by interne protocol (“ip”) address. As another example, in some embodiments, identifier packet 305 identifies such users by another unique client-specific code. In some such embodiments configured to route a data packet (such as the encrypted data 303 within change object 301) to each and every user-designated recipient (such as a subset of other authorized clients), the control system within hub 107 reads one or more of such identifier packet(s) to determine the authorized and designated users for receiving the plaintext version of encrypted data (such as encrypted data 303), and then forwards such a change object(s) (such as 301) to each of those addresses. In some such embodiments, the control system so forwards such a change object(s) after duplicating it. But, in at least some embodiments, identifier packet 305 does not include any of the underlying plaintext data corresponding with encrypted data 303, and, therefore, cloud-based hub 107 never holds, and may not lose control of, that unencrypted data (e.g., via a bad actor hacking the servers of hub 107). In some embodiments, a plurality of change objects, as discussed above, which incorporate a subset of all changes made to a document or other data maintained by the control system may be distributed to particular users based on rules. For example, in some such embodiments, such rules are provided in an identifier packet or other metadata of the change object. In some such embodiments, such rules are provided in the document itself. For example, in some such embodiments, a first instance of a document that one or more later-distributed change object change is distributed to users prior to the one or more change objects. Such a first instance contains such rules, which are then implemented by the control system with respect to such later one or more change objects. In some embodiments, such rules are implemented by issuing a different symmetric key for encoding and decoding each different change object, and only issuing those symmetric keys to users authorized to receive them. In some embodiments, such rules are implemented by issuing a different symmetric key for encoding and decoding each of a plurality of subsets of changes, and only issuing those symmetric keys to users authorized to receive them. In some embodiments with rule-setting with a plurality of distinct symmetric keys, as discussed above, and in accordance with aspect of the present invention, one or more designated key bundles is created for each particular authorized user. Each such particular authorized user then receives such a designated key bundle, encoded with that particular authorized user's public key. In some such embodiments, such a key bundle only includes symmetric keys for data that the particular authorized user is authorized to receive, in accordance with such rules, thus implementing such rules.

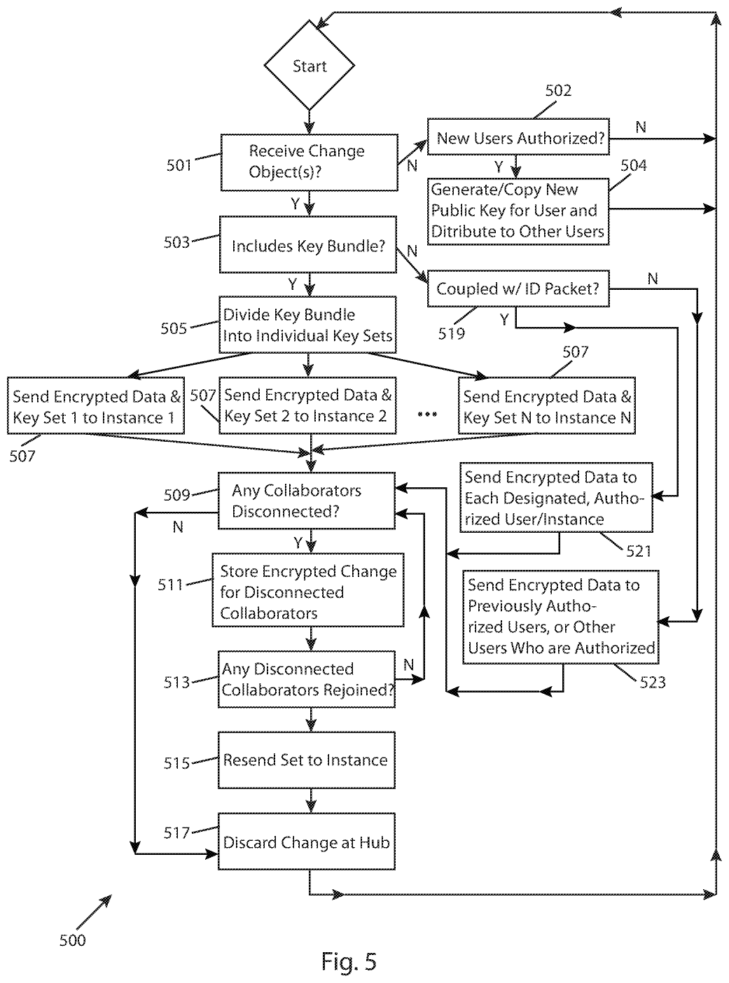

FIG. 4 is a schematic block diagram of some example elements of an example control system 400, incorporating a machine-readable medium, that may be used to implement various aspects of the present invention, some of which aspects are described in reference to FIGS. 1 through 3 above, and FIG. 5, below. The generic and other components and aspects described herein are not exhaustive of the many different control systems and variations, including a number of possible hardware aspects and machine-readable media, that might be used, in accordance with the invention. Rather, the control system 400 is described here to make clear how aspects may be implemented.

Among other components, the control system 400 may include an input/output device 401, a memory device 403, longer-term, deep data storage media and/or other data storage device 405, and a processor or processors 407. The processor(s) 407 is (are) capable of receiving, interpreting, processing and manipulating signals and executing instructions for further processing and for output, pre-output and/or storage in and outside of the control system. The processor(s) 407 may be general or multipurpose, single- or multi-threaded, and may have a single core or several processor cores, including microprocessors, in some embodiments. Among other things, the processor(s) is (are) capable of processing signals and instructions for the input/output device 401, in various embodiments discussed in this application: to manage and route symmetric and asymmetric encryption keys, and packets thereof, and data encrypted therewith, as well as register, authorize and designate as change object and data recipients user's of SaaS, and to cause a user interface to be provided or modified for use by a user on hardware, such as, but not limited to, a personal computer monitor or terminal monitor with a mouse and keyboard and presentation and input-facilitating software (as in a GUI), or other suitable GUI presentation system, to carry out a secure, cloud-based collaborative work environment in accordance with any and all aspects and embodiments of the invention set forth in this application.

For example, in some embodiments, user interface aspects may present clients or other users with the option to command other aspects of the control system to run a document editing and collaborative work program, managing the creation and/or distribution of encrypted data therefor, through the use of change objects and identifier packet(s), and through other techniques set forth in this application, and to carry out any other actions set forth in this application for a control system. The processor(s) 407 is/are capable of processing instructions stored in memory devices 405 and/or 403 (or ROM or RAM), and may communicate via system buses 475. Input/output device 401 is capable of input/output operations for the control system 400, and may include and communicate through innumerable input and/or output hardware, and innumerable instances thereof, such as a computer mouse(s), or other sensors, actuator(s), communications antenna, keyboard(s), smartphone(s) and/or PDA(s), networked or connected additional computer(s), camera(s) or microphone(s), mixing board(s), real-to-real tape recorder(s), external hard disk recorder(s), additional movie and/or sound editing system(s) or gear, speaker(s), external filter(s), amp(s), preamp(s), equalizer(s), filtering device(s), stylus(es), gesture recognition hardware, speech recognition hardware, computer display screen(s) or touch screen(s). Such a display device or unit and other input/output devices could implement a program or user interface created by machine-readable means, such as software (e.g., of a nature set forth in this application), permitting the system and user to carry out the user settings, commands and other input discussed in this application. 401, 403, 405, and 407 are connected and able to send and receive communications, transmissions and instructions via system bus(ses) 475. Deep storage media device 405 is capable of providing mass storage for the system, and may be a computer-readable medium, may be a connected mass storage device (e.g., flash drive or other drive connected to a U.S.B. port or Wi-Fi) may use back-end or cloud storage over a network (e.g., the Internet) as either a memory backup for an internal mass storage device or as a primary memory storage means, or may simply be an internal mass storage device, such as a computer hard drive or optical drive.

Generally speaking, the system may be implemented as a client/server arrangement, where features of the invention are performed on a remote server, networked to the client and made a client and server by software on both the client computer and server computer. System 400 is capable of accepting input from any of those devices and systems 409-419, and modifying stored data within them and within itself, based on any input or output sent through input/output device 401.

Input and output devices may deliver their input and receive output by any known means, including, but not limited to, any of the hardware and/or software examples shown as 409-419.

While the illustrated system example 400 may be helpful to understand the implementation of aspects of the invention, any suitable form of computer system known in the art may be used—for example, a simpler computer system containing just a processor for executing instructions from a memory or transmission source. The aspects or features set forth may be implemented with, and in any combination of, digital electronic circuitry, hardware, software, firmware, modules, languages, approaches or any other computing technology known in the art, any of which may be aided with external data from external hardware and software, optionally, by networked connection, such as by LAN, WAN or the many connections forming the Internet. The system can be embodied in a tangibly-stored computer program, as by a machine-readable medium and propagated signal, for execution by a programmable processor. The method steps of the embodiments of the present invention may be performed by such a programmable processor, executing a program of instructions, operating on input and output, and generating output and stored data. A computer program includes instructions for a computer to carry out a particular activity to bring about a particular result, and may be written in any programming language, including compiled and uncompiled and interpreted languages and machine language, and can be deployed in any form, including a complete program, module, component, subroutine, or other suitable routine for a computer program.

FIG. 5 is a process flow diagram, setting forth several example steps 501 that may be undertaken by a control system (such as the example control system set forth above, in reference to FIG. 4) implementing embodiments of the present invention (e.g., through software executed on control system hardware described throughout this application), including, but not limited to, aspects related to the secure provision of data and SaaS. Beginning with step 501, the control system may determine whether a change object, such as any of the change objects discussed above in this application, has been received from any user connected with the hub comprising (or comprised within) the control system. If so, the control system proceeds to step 503, in which it next determines whether the change object comprises a key bundle, comprising a symmetric key encrypted by the public key of each user authorized to collaborate on (symmetrically encrypted) project data within the change object and/or the SaaS provided and/or managed by the hub and control system, as discussed in greater detail elsewhere in this application. If such a key bundle is determined to exist within the change object, the control system next proceeds to step 505, in which it separates the key bundle into the individual key data portions, one each for each such authorized user, and each of which key data portions of the key bundle comprise the symmetric key encrypted with a single authorized user's public key (generated for each new user through asymmetric encryption, in steps 502 et seq, discussed further below). This may be done without the hub decrypting any data, by providing packets or other data markers, designating parts of the encrypted code that are the key data portions for each user. The control system next sends (or attempts to send) a copy of the symmetrically encrypted project data coupled with the symmetric key encrypted with an authorized user's public key to each such user's device, for decryption and use, presentation, editing and management at his, her or its device and instance of the SaaS, in steps 507. In at least some embodiments, also in steps 507, the control system also sends to each authorized user, along with the copy of the symmetrically encrypted data, the separated individual key data portion, and, in some embodiments, only that key daya portion, of the key bundle that comprises a copy of the symmetric key encrypted by that user's public key.

Proceeding to step 509, the control system next determines whether any users authorized and designated as collaborators who may use the encrypted data (i.e., are authorized to receive the encrypted project data within the change object) are currently not connected to the hub (and control system), and, therefore, are not able to receive their copy of the symmetrically encrypted data and the key data portion that is the symmetric key encrypted with the user's public key, in one of steps 507. If so, the control system next proceeds to step 511, in which it stores a copy of the symmetrically encrypted data and that key data portion, for later distribution to any such disconnected user, as set forth immediately below. If the control system subsequently determines that any of such disconnected users have reconnected with the hub (and control system), in step 513, and are therefore able to receive data from it, the control system then may proceed to step 515, in which it again (as in step 507) sends or attempts to send the user a copy of the symmetrically encrypted data and the key data portion that is the symmetric key encrypted with each such user's public key. If any of such disconnected users still have not reconnected, in step 513, the control system may simply check again, repeating step 513, until that user connects to the hub. Once all such disconnected users have connected, and all copies of the encrypted data and key data portions have been sent to all authorized users, the hub may then discard any copy of the change object, encrypted data, key bundles and key portions, in some embodiments, in step 517. In some embodiments, however, the hub may retain any or all of those data, for instance, for later re-issuing or matching information related to any of the keys with particular users. In some embodiments, such a change object may include an entire document of a document management program managed by the control system as an SaaS. In some such embodiments, such an entire document may be the latest state (a.k.a. “version”) of a document subject to collaborative editing by the users, reflecting all effective changes to the document appearing in that version of the document (a.k.a. a latest “snapshot” of the document). In other embodiments, such a document or snapshot may be encoded within a series of such change objects. For example, in some such embodiments, such a series of change objects reflect a sequence of changes to a document at different times, each change being encoded in a separate change object. In such embodiments, each such change object is stored and distributed to users in the manner set forth above, to each authorized user, until each user has a copy of the document reflecting all of the latest changes to the document. If, at step 509, the control system determined that none of the authorized users were not connected to the hub, the control system could proceed directly to step 517, immediately deleting any such data that will not be so used, as the case may be in each embodiment. The control system then returns to the starting position.

As mentioned in reference to FIGS. 2 and 3, above, in some cases, a change object may not comprise a key bundle and, instead, may simply comprise the data encrypted with a symmetric key, along with an identifier packet, for aiding the control system in routing the symmetric key to all authorized users devices and instances of the SaaS managed by the hub and users. Accordingly, in step 503, as mentioned above, the control system may determine that such a change object, without a key bundle, has been received, in which case it proceeds to step 519. As also mentioned above, however, even where a change object does not comprise a key bundle, it may instead comprise an identifier packet, which may identify each and every user authorized and designated to receive the new encrypted data. If so, in step 519, the control system may determine that such a change object, with an identifier packet, has been received, in which case it proceeds to step 521. In step 521, the control system reads the identifier packet and determines which users have been identified as authorized to receive the data encrypted with a symmetric key, and sends a copy of the data encrypted with the symmetric key to each such user. In some embodiments, if no identifier packet is present in the change object and/or no authorized users are identified within an identifier packet, the control system may proceed to step 523, in which it may nonetheless send the encrypted data to each user of the SaaS previously-authorized to receive data, or data related to the same project to which the encrypted data relates (as otherwise determined—e.g., by other project designating markers within the change object). The control system may then run through each of subsequent steps 509, et seq., as discussed above, treating all such users as authorized collaborators with respect to the encrypted data.

If the control system has not received a change object, in initial step 501, the control system may proceed to step 502, in which it determines whether new devices or users have been authorized to collaborate on data using the SaaS (e.g., through an administrative user granting that user an account and license to create and operate an instance of the SaaS on one of more computer hardware devices). If such a new user has been so authorized, the control system may proceed to step 504, in which a new public key and corresponding private key for that use is generated (preferably, by the user's device) through asymmetric cryptography techniques, and the hub distributes that new user's public key to all other user's authorized and collaborating on that data (the private key being retained exclusively by that new user). The control system may then return to the starting position.

It should be noted that the steps, and all embodiments, set forth above are illustrative, not exhaustive, of the many different number and sequences of steps and arrangements of embodiments that may be executed to carry out aspects of the present invention, which are virtually unlimited. As will be readily apparent to those of ordinary skill in the art, all such alternate orders, numbers, partial sequences, or any other part of the techniques fall within the scope of the invention.

We claim:

1. A system for managing data sharing by a plurality of users, comprising:
a control system within a hub, comprising computer hardware configured to:
obtain a unique public key of at least one unique asymmetric public-private key pair for each of said plurality of users;
distribute said unique public key for each of said plurality of users to users that do not yet possess said unique public key;
obtain symmetrically encrypted data from at least one of said users, wherein said symmetrically encrypted data is packaged with a key bundle;
wherein said key bundle comprises at least one symmetric key used to encrypt said encrypted data, and wherein said at least one symmetric key is encrypted with each said unique public key of at least one unique asymmetric public-private key pair for each of said users.

2. The system for managing data sharing of claim 1, wherein the key bundle and the symmetrically encrypted data are combined in a single change object.

3. The system for managing data sharing of claim 2, wherein the symmetrically encrypted data and the change object relate to a change to data being provided to clients of SaaS.

4. The system for managing data sharing of claim 3, wherein the SaaS is cloud-based.

5. The system for managing data sharing of claim 4, wherein the computer hardware is a cloud-based hub, providing the SaaS to said clients.

6. The system for managing data sharing of claim 5, wherein the computer hardware is configured to provide access to the SaaS by each SaaS client only upon said each SaaS client passing an authentication challenge.

7. The system for managing data sharing of claim 5, wherein the computer hardware is configured to provide access to data by each SaaS client only upon said each SaaS client passing an authentication challenge.

8. The system for managing data sharing of claim 3, wherein the system routes the change object to authorized SaaS clients only.

9. The system for managing data sharing of claim 3, wherein the system routes the change object to authorized SaaS clients that are authorized specifically to receive the change object.

10. The system for managing data sharing of claim 9, wherein the change object comprises metadata, and wherein the system routes the change object based on said metadata.

11. The system for managing data sharing of claim 9, wherein the change object comprises at least one identifier packet, and wherein the system routes the change object based on said at least one identifier packet.

12. The system for managing data sharing of claim 2, wherein the control system maintains a copy of the change object for each of a subset of said plurality of users that have not yet accessed said change object.

13. The system for managing data sharing of claim 12, wherein the control system maintains said copy of the change object for said each of a subset of said plurality of users that have not yet accessed said change object until said each of a subset of said plurality of users that have not yet accessed said change object are connected with said control system.

14. The system for managing data sharing of claim 13, wherein the change object comprises an encrypted document, and wherein the encrypted document comprises the latest state of the document, reflecting all changes made by authorized users collaboratively editing said document.

15. The system for managing data sharing of claim 1, wherein said at least one symmetric key is a plurality of symmetric keys.

16. The system for managing data sharing of claim 15, wherein a different symmetric key is generated for each change object.

17. The system for managing data sharing of claim 15, wherein different symmetric keys are issued to different users, of said plurality of users, to control access to data changes by said different users based on rules.

18. The system for managing data sharing of claim 15, wherein a different bundle of said symmetric keys is provided to each of said plurality of users.

19. A method for managing data sharing by a plurality of users, comprising the following steps:
providing a system for managing data sharing by a plurality of users, comprising:
a control system, comprising computer hardware configured to:
obtain a unique public key of at least one unique asymmetric public-private key pair for each of said plurality of users;
distribute said unique public key for each of said plurality of users to users that do not yet possess said unique public key;
obtain symmetrically encrypted data from at least one of said users, wherein said symmetrically encrypted data is packaged with a key bundle;
wherein said key bundle comprises a symmetric key used to encrypt said encrypted data, and wherein said symmetric key is encrypted with each said unique public key of at least one unique asymmetric public-private key pair for each of said users.

20. The method for managing data sharing by a plurality of users of claim 19, wherein the SaaS is cloud-based.
